(19) United States
(12) Patent Application Publication
(10) Pub. No.: US 2015/0058210 A1
(43) Pub. Date: Feb. 26, 2015

(54) METHODS AND SYSTEMS FOR DETERMINING AVAILABILITY OF A PAYMENT PROCESSING SYSTEM

(71) Applicant: TicketZen, Inc., Boston, MA (US)

(72) Inventors: Cortlandt E. Johnson, II, Boston, MA (US); Jeremy Weiskotten, Ashburnham, MA (US); Joseph F. Lind, IV, Cambridge, MA (US); David Jeffrey Chupp, JR., Cambridge, MA (US); Ryan Neu, Boston, MA (US)

(21) Appl. No.: 14/462,681

(22) Filed: Aug. 19, 2014

Related U.S. Application Data
(60) Provisional application No. 61/867,633, filed on Aug. 20, 2013.

(51) Int. Cl. G06Q 20/10; G06Q 20/08; H04L 29/08

(52) U.S. Cl. CPC G06Q 20/102; H04L 67/16; G06Q 20/085
USPC 705/40

(57) ABSTRACT

A method for monitoring for a new fine includes receiving, by a first computing device, a user identifier and credit card information associated with the user identifier. The method includes transmitting, by the first computing device, the user identifier to a second computing device associated with a ticketing authority. The method includes receiving, by the first computing device, an indication that no fine is associated with the user identifier. The method includes retransmitting, by the first computing device, to the second computing device, the user identifier. The method includes receiving, by the first computing device, from the second computing device, data identifying a fine owed by a user associated with the user identifier. The method includes automatically paying the fine, by the first computing device, with the credit card information, for the user associated with the user identifier.

### CROSS-REFERENCE TO RELATED APPLICATIONS

This application claims priority from U.S. Provisional Patent Application No. 61/867,633, filed on Aug. 20, 2013, entitled “Methods and Systems for Determining Availability of a Payment Processing System,” which is hereby incorporated by reference.

### BACKGROUND

The disclosure relates to payment of fines. More particularly, the methods and systems described herein relate to functionality for determining the availability of a payment processing system.

In addition to being a source of unexpected stress and financial difficulty, the fines that are conventionally issued on an ad hoc basis by officials (e.g., parking tickets) are often inconvenient to pay. Such fines are not typically available for payment until they have been entered into a system belonging to the enforcement body that issued the fines, which frequently does not occur until hours or days have elapsed. This means that the person subject to the fine may lose the opportunity to pay the fine when it is freshest in that person's memory. Furthermore, the fines are often issued as paper tickets affixed to a vehicle, which can be taken by mischievous persons or lost due to inclement weather, leaving the recipient unaware that the ticket was ever issued. These problems are compounded when the recipient is travelling, and may pass through a number of jurisdictions with differing rules and enforcement practices.

### BRIEF SUMMARY

In one aspect, a method for monitoring for a new fine includes receiving, by a first computing device, a user identifier and credit card information associated with the user identifier. The method includes transmitting, by the first computing device, the user identifier to a second computing device associated with a ticketing authority. The method includes receiving, by the first computing device, an indication that no fine is associated with the user identifier. The method includes retransmitting, by the first computing device, to the second computing device, the user identifier. The method includes receiving, by the first computing device, from the second computing device, data identifying a fine owed by a user associated with the user identifier. The method includes automatically paying the fine, by the first computing device, with the credit card information, for the user associated with the user identifier.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIGS. 1A-1C are block diagrams depicting embodiments of computers useful in connection with the methods and systems described herein;

FIG. 2 is a block diagram depicting an embodiment of a system for determining the availability of a payment processing system;

FIG. 3A is a block diagram depicting one embodiment of a user interface with which users may provide data identifying fines;

FIG. 3B is a block diagram depicting one embodiment of a user interface with which users may scan a ticket;

FIG. 3C is a block diagram depicting one embodiment of a user interface with which a user may view an enumeration of fines available for payment;

FIG. 3D is a block diagram depicting one embodiment of a user interface with which a user may view the data identifying the fine;

FIG. 4 is a block diagram depicting another embodiment of a system for determining the availability of a payment processing system;

FIG. 5 is a flow diagram depicting an embodiment of a method for determining the availability of a payment processing system;

FIG. 6 is a flow diagram depicting another embodiment of another method for determining the availability of a payment processing system;

FIG. 7 is a block diagram depicting one embodiment of a system for monitoring for a new fine owed by a user;

FIG. 8 is a flow diagram depicting one embodiment of a method for monitoring for a new fine owed by a user; and

FIG. 9 is a flow diagram depicting one embodiment of a method for monitoring for a new fine owed by a user.

### DETAILED DESCRIPTION

In some embodiments, the methods and systems described herein provide functionality for determining the availability of a payment processing system. Before describing these methods and systems in detail, however, a description is provided of a network in which such methods and systems may be implemented.

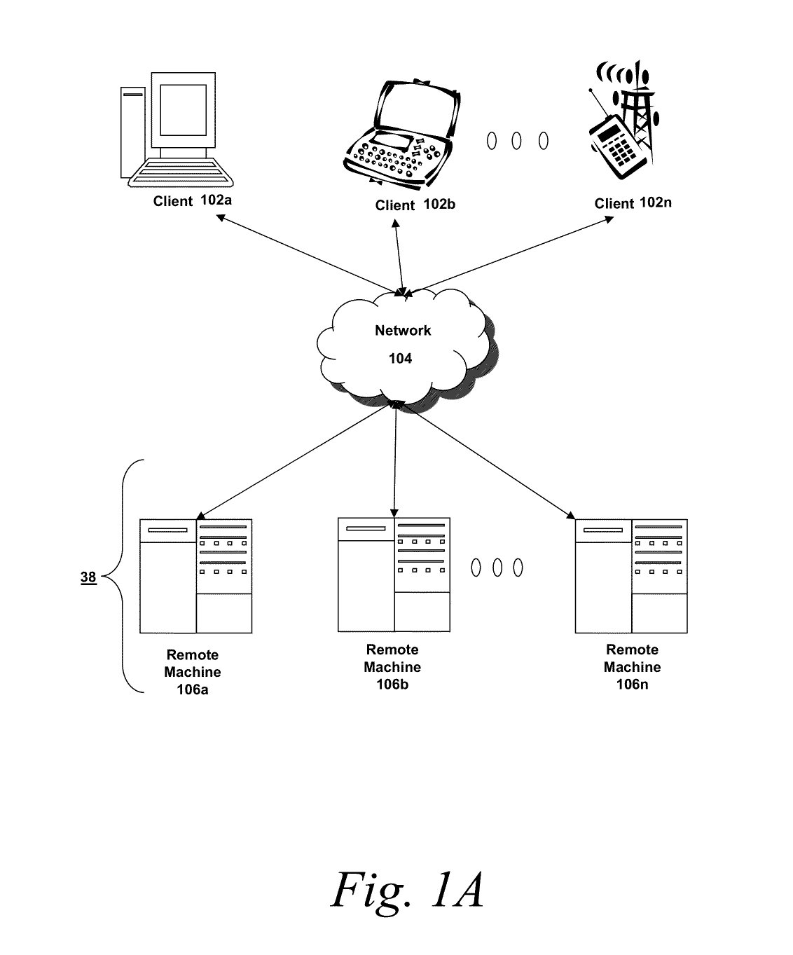

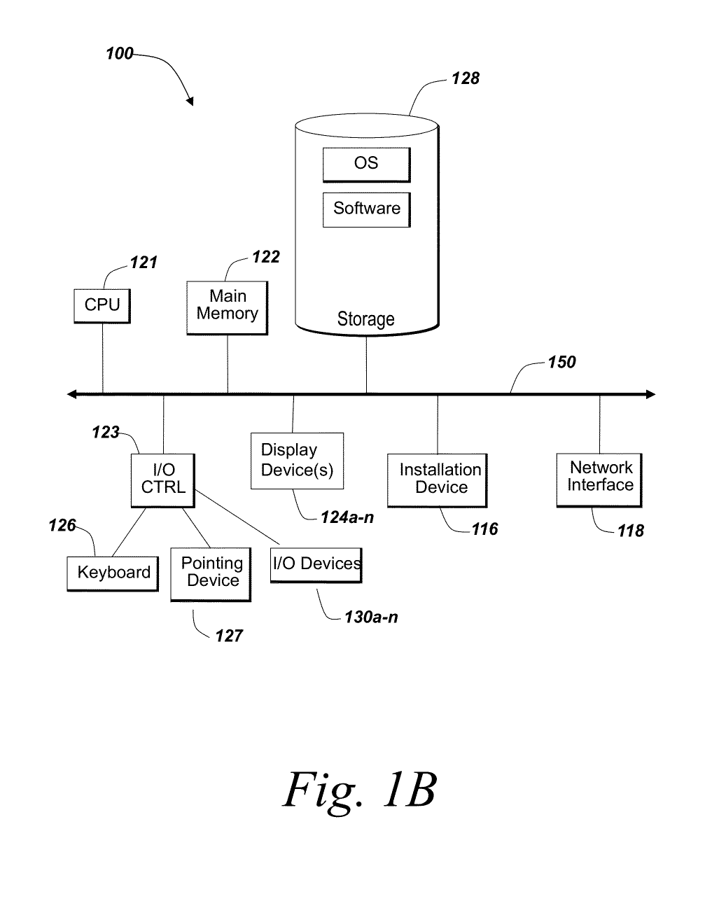

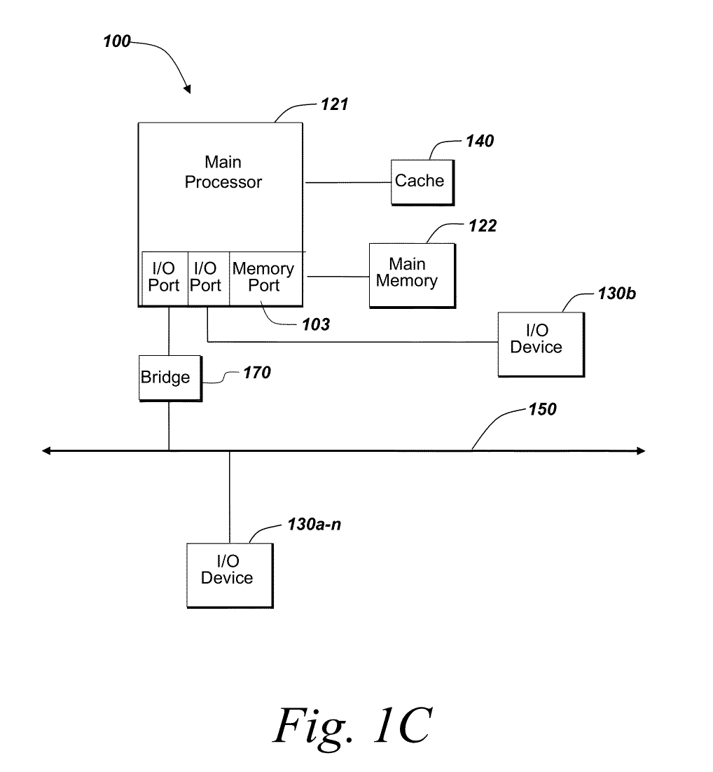

Referring now to FIG. 1A, an embodiment of a network environment is depicted. In brief overview, the network environment comprises one or more clients 102a-102n (also generally referred to as local machine(s) 102, client(s) 102, client node(s) 102, client machine(s) 102, client computer(s) 102, client device(s) 102, computing device(s) 102, endpoint(s) 102, or endpoint node(s) 102) in communication with one or more remote machines 106a-106n (also generally referred to as server(s) 106 or computing device(s) 106) via one or more networks 104.

Although FIG. 1A shows a network 104 between the clients 102 and the remote machines 106, the clients 102 and the remote machines 106 may be on the same network 104. The network 104 can be a local area network (LAN), such as a company Intranet, a metropolitan area network (MAN), or a wide area network (WAN), such as the Internet or the World Wide Web. In some embodiments, there are multiple networks 104 between the clients 102 and the remote machines 106. In one of these embodiments, a network 104′ (not shown) may be a private network and a network 104 may be a public network. In another of these embodiments, a network 104 may be a private network and a network 104′ a public network. In still another embodiment, networks 104 and 104′ may both be private networks.

The network 104 may be any type and/or form of network and may include any of the following: a point to point network, a broadcast network, a WAN, a LAN, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 104 may comprise a wireless link, such as an infrared channel or satellite band. The topology of the network 104 may be a bus, star, or ring network topology. The network 104 may be of any such network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS, or UMTS. In some embodiments, different types of data may be transmitted via different protocols. In other embodiments, the same types of data may be transmitted via different protocols.

A client 102 and a remote machine 106 (referred to generally as computing devices 100) can be any workstation; desktop computer; laptop or notebook computer; server; portable computer; mobile telephone or other portable telecommunication device; media playing device; a gaming system; a mobile computing device; or any other type and/or form of computing, telecommunications or media device that is capable of communicating on any type and form of network and that has sufficient processor power and memory capacity to perform the operations described herein. A client 102 may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on client 102.

In one embodiment, a computing device 106 provides functionality of a web server. In some embodiments, a web server 106 comprises an open-source web server, such as the APACHE servers maintained by The Apache Software Foundation of Forest Hill, Md. In other embodiments, the web server executes proprietary software, such as the Internet Information Services products provided by Microsoft Corporation of Redmond, Wash., the Oracle iPlanet web server products provided by Oracle Corporation of Redwood Shores, Calif., or the BEA WEBLOGIC products provided by BEA Systems of Santa Clara, Calif.

In some embodiments, the system may include multiple, logically-grouped remote machines 106. In one of these embodiments, the logical group of remote machines may be referred to as a server farm 38. In another of these embodiments, the server farm 38 may be administered as a single entity.

FIGS. 1B and 1C depict block diagrams of a computing device 100 useful for practicing an embodiment of the client 102 or a remote machine 106. As shown in FIGS. 1B and 1C, each computing device 100 includes a central processing unit 121, and a main memory unit 122. As shown in FIG. 1B, a computing device 100 may include a storage device 128, an installation device 116, a network interface 118, an I/O controller 123, display devices 124a-n, a keyboard 126, a pointing device 127, such as a mouse, and one or more other I/O devices 130a-n. The storage device 128 may include, without limitation, an operating system and software. As shown in FIG. 1C, each computing device 100 may also include additional optional elements, such as a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. The computing device 100 may be based on any of these processors, or any other processor capable of operating as described herein.

The main memory unit 122 may be one or more memory chips capable of storing data and allowing any storage location to be directly accessed by the microprocessor 121. The main memory 122 may be based on any available memory chips capable of operating as described herein. In the embodiment shown in FIG. 1B, the processor 121 communicates with main memory 122 via a system bus 150. FIG. 1C depicts an embodiment of a computing device 100 in which the processor communicates directly with main memory 122 via a memory port 103. FIG. 1C also depicts an embodiment in which the main processor 121 communicates directly with cache memory 140 via a secondary bus, sometimes referred to as a backside bus. In other embodiments, the main processor 121 communicates with cache memory 140 using the system bus 150.

In the embodiment shown in FIG. 1B, the processor 121 communicates with various I/O devices 130 via a local system bus 150. Various buses may be used to connect the central processing unit 121 to any of the I/O devices 130, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 121 may use an Advanced Graphics Port (AGP) to communicate with the display 124. FIG. 1C depicts an embodiment of a computer 100 in which the main processor 121 also communicates directly with an I/O device 130b via, for example, HYPERTRANSPORT, RAPIDIO, or INFINIBAND communications technology.

A wide variety of I/O devices 130a-130n may be present in the computing device 100. Input devices include keyboards, mice, trackpads, trackballs, microphones, scanners, cameras, and drawing tablets. Output devices include video displays, speakers, inkjet printers, laser printers, and dye-sublimation printers. An I/O controller 123 as shown in FIG. 1B may control the I/O devices. Furthermore, an I/O device may also provide storage and/or an installation device 116 for the computing device 100. In some embodiments, the computing device 100 may provide USB connections (not shown) to receive handheld USB storage devices such as the USB Flash Drive line of devices manufactured by Twintech Industry, Inc. of Los Alamitos, Calif.

Referring still to FIG. 1B, the computing device 100 may support any suitable installation device 116, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. The computing device 100 may further comprise a storage device, such as one or more hard disk drives or redundant arrays of independent disks, for storing an operating system and other software.

Furthermore, the computing device 100 may include a network interface 118 to interface to the network 104 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax, and direct asynchronous connections). In one embodiment, the computing device 100 communicates with other computing devices 100′ via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

In further embodiments, an I/O device 130 may be a bridge between the system bus 150 and an external communication bus such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIGS. 1B and 1C typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, and WINDOWS VISTA, all of which are manufactured by Microsoft Corporation of Redmond, Wash.; MAC OS manufactured by Apple Inc. of Cupertino, Calif.; OS/2 manufactured by International Business Machines of Armonk, N.Y.; and Linux, a freely-available operating system distributed by Caldera Corp. of Salt Lake City, Utah, or any type and/or form of a Unix operating system, among others.

The computing device 100 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communication and that has sufficient processor power and memory capacity to perform the operations described herein. In some embodiments, the computing device 100 may have different processors, operating systems, and input devices consistent with the device. In other embodiments, the computing device 100 is a mobile device such as a JAVA-enabled cellular telephone or personal digital assistant (PDA). The computing device 100 may be a mobile device such as those manufactured, by way of example and without limitation, by Motorola Corp. of Schaumburg, Ill.; Kyocera of Kyoto, Japan; Samsung Electronics Co., Ltd. of Seoul, Korea; Nokia of Finland; Hewlett-Packard Development Company, L.P. and/or Palm, Inc. of Sunnyvale, Calif.; Sony Ericsson Mobile Communications AB of Lund, Sweden; or Research In Motion Limited of Waterloo, Ontario, Canada (doing business as “Blackberry”). In yet other embodiments, the computing device 100 is a smart phone, Pocket PC, Pocket PC Phone, or other portable mobile device supporting Microsoft Windows Mobile Software.

In some embodiments, the computing device 100 is a digital audio player. In one of these embodiments, the computing device 100 is a digital audio player such as the Apple IPOD, IPOD Touch, IPOD NANO, and IPOD SHUFFLE lines of devices manufactured by Apple Inc. of Cupertino, Calif. In another of these embodiments, the digital audio player may function as both a portable media player and as a mass storage device. In other embodiments, the computing device 100 is a digital audio player such as those manufactured by, for example and without limitation, Samsung Electronics America of Ridgefield Park, N.J.; Motorola Inc. of Schaumburg, Ill.; or Creative Technologies Ltd. of Singapore. In yet other embodiments, the computing device 100 is a portable media player or digital audio player supporting file formats including, but not limited to, MP3, WAV, M4A/AAC, WMA Protected AAC, AEFF, Audible audiobook, Apple Lossless audio file formats, and .mov, .m4v, and .mp4 MPEG-4 (H.264/MPEG-4 AVC) video file formats.

In some embodiments, the computing device 100 comprises a combination of devices such as a mobile phone combined with a digital audio player or portable media player. In one of these embodiments, the computing device 100 is a device in the Motorola line of combination digital audio players and mobile phones. In another of these embodiments, the computing device 100 is a device in the iPhone smartphone line of devices manufactured by Apple Inc. of Cupertino, Calif. In still another of these embodiments, the computing device 100 is a device executing the Android open source mobile phone platform distributed by the Open Handset Alliance; for example, the device 100 may be a device such as those provided by Samsung Electronics of Seoul, Korea or HTC Headquarters of Taiwan, R.O.C. In other embodiments, the computing device 100 is a tablet device such as, for example and without limitation, the iPad line of devices manufactured by Apple Inc.; the PlayBook manufactured by Research In Motion; the Cruz line of devices manufactured by Velocity Micro, Inc. of Richmond, Va.; the Folio and Thrive line of devices manufactured by Toshiba America Information Systems, Inc. of Irvine, Calif.; the Galaxy line of devices manufactured by Samsung; the HP Slate line of devices manufactured by Hewlett-Packard; and the Streak line of devices manufactured by Dell, Inc. of Round Rock, Tex.

In one embodiment, the computing device 100 stores data in a database. In some embodiments, the database is an ODBC-compliant database. For example, the database may be provided as an ORACLE database manufactured by Oracle Corporation of Redwood Shores, Calif. In other embodiments, the database can be a Microsoft ACCESS database or a Microsoft SQL server database manufactured by Microsoft Corporation of Redmond, Wash. In still other embodiments, the database may be a custom-designed database based on an open source database, such as the MYSQL family of freely available database products distributed by MySQL AB Corporation of Uppsala, Sweden. In other embodiments, examples of databases include, without limitation, structured storage (e.g., NoSQL-type databases and BigTable databases), HBase databases distributed by The Apache Software Foundation of Forest Hill, Md., MongoDB databases distributed by 10Gen, Inc. of New York, N.Y., and Cassandra databases distributed by The Apache Software Foundation. In further embodiments, the database may be any form or type of database.

In some embodiments, the methods and systems described herein provide functionality for detecting fines and enabling users to pay them. Additionally, some embodiments of the systems and methods described herein provide functionality for searching for a fine based upon the geographical and jurisdictional locations of a user and/or information included in the issued fine, and/or for detecting when the system of the payee has been updated so that the user can pay the obligation, and/or for automatically processing payments.

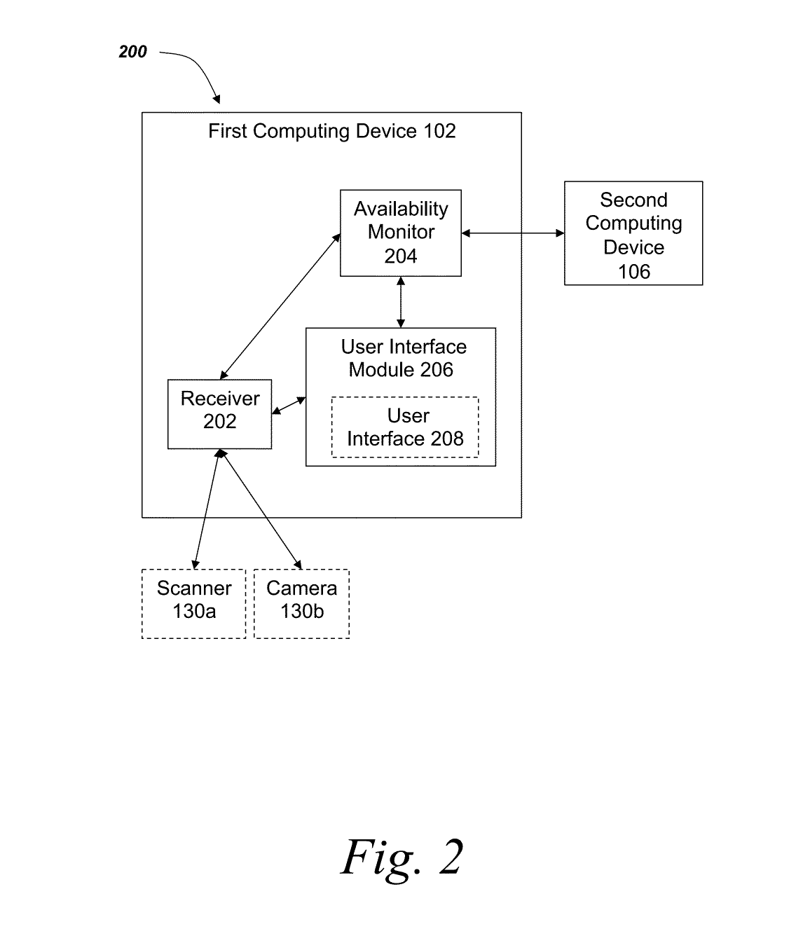

Referring now to FIG. 2, a block diagram depicts one embodiment of a system 200 for determining the availability of a payment processing system. In brief overview, the system includes a first computing device 102 and a second computing device 106. The first computing device 102 executes a receiver 202, an availability monitor 204, and a user interface module 206.

In some embodiments, the methods and systems described herein provide functionality for determining the availability of an electronic payment system for paying a fine. A fine may be any legal obligation a user of the system 200 has to pay another entity. For example, a fine may be incurred as a penalty for violating a provision of a rule governing a relationship between the user and the entity. In some embodiments, a fine is a parking ticket. In some embodiments, a fine is a citation issued for a motor vehicle violation. In some embodiments, a fine is a contractually mandated penalty. Data concerning a fine may include data identifying the user or vehicle to whom the fine pertains. Data concerning a fine may include an account number identifying the fine. Data concerning a fine may include an amount the user owes pursuant to the obligation.

A fine may be recorded on a ticket. A ticket in some embodiments is any physical device, item, or material on which information identifying a fine is stored in a form in which it may be scanned by a scanner 130a or by a camera 130b. The information may be printed on the ticket. The information may be handwritten on the ticket. The information may be encoded on the ticket as a bar code. The information may be encoded on the ticket as a quick read (QR) code. The information may be encoded on the ticket as an RFID tag. The information may be encoded on the ticket in magnetic form.

Some embodiments of the system and methods described herein involve communication with payment processing systems. A payment processing system, in some embodiments, is at least one device that receives electronic payment of fines on behalf of the entity to which the fine is owed (e.g., a ticket authority). In some embodiments, the second computing device 106 is the payment processing system. In other embodiments, the second computing device 106 communicates with a payment processing system (not shown). In some embodiments, the second computing device 106 is part of the processing system belonging to the entity to which the fine is owed. In some embodiments, a payment processing system is available when the system 200 is able to pay the fine using the payment processing system, via the second computing device 106. In other embodiments, the second computing device 106 is any computing device 100 owned by, maintained by, accessed by, storing data owned by, or otherwise associated with a ticket authority and/or a payment processing system owned by, maintained by, accessed by, storing data owned by, or otherwise associated with the ticket authority.

Referring still to FIG. 2, and in greater detail, the system 200 includes a first computing device 102 and a second computing device 106. The computing devices 102 and 106 may be computing devices 100 as described above in connection with FIGS. 1A-1C.

In some embodiments, the receiver 202 is provided as part of a software application operating on the first computing device 102. The receiver 202 in some embodiments communicates with a scanner 130a accessible to the first computing device 102. In some embodiments, the scanner 130a is any device that senses electromagnetic patterns from its environment and converts those patterns into digital information. The scanner 130a may be an optical scanner. The scanner 130a may be a laser scanner; for instance, the scanner 130a may be adapted to read bar codes. The scanner 130a may be a magnetic reader. The scanner 130a may be a radio frequency identification (RFID) reader. The scanner 130a may be separate from the first computing device 102. The scanner 130a may be connected to the first computing device 102 by means set forth above in reference to FIGS. 1A-1C. The scanner 130a may be integrated in the body of the first computing device 102. For example, the first computing device 102 may be a mobile device, and the scanner 130a may be a digital camera built into the first computing device 102.

In some embodiments, the first computing device 102 includes a camera 130b for taking a digital photograph of the ticket. The camera 130b may be separate from the first computing device 102. The camera 130b may be connected to the first computing device 102 by means set forth above in reference to FIGS. 1A-1C. The camera 130b may be integrated in the body of the first computing device 102. For example, the first computing device 102 may be a mobile device, and the camera 130b may be a digital camera built into the first computing device 102. In some embodiments, the receiver 202 also includes means for retrieving the digital photograph from a storage medium (not shown). The storage medium may be any memory accessible to the first computing device 102, as set forth above in reference to FIGS. 1A-1C. Means for retrieving the digital photograph from the storage medium may include any means for retrieving data from memory as described above in reference to FIGS. 1A-1C. In some embodiments, the receiver also provides means for receiving, from the camera 130b, the digital photograph. Means for receiving the digital photograph from the camera 130b may include any means for the reception of data by a computing device 100 from another device as set forth above in reference to FIGS. 1A-1C.

In some embodiments, the receiver 202 includes means for applying an optical character recognition (OCR) process to the digital photograph. In some embodiments, an OCR process is a process whereby a computing device 100, as set forth above in reference to FIGS. 1A-1C, identifies textual images from a scanned image and stores the identified images as characters in memory accessible to the computing device 100. By way of example, the scanned image may be a digital photograph. The scanned image may be a scanned document. In some embodiments, textual images include any images that make up the writing system of a human language. Textual images in some embodiments include letters from alphabetic writing systems such as the Roman, Greek, and Arabic alphabets. Textual images in some embodiments include punctuation marks. Textual images may include logographic characters, such as those used for writing Mandarin. Textual images may include syllabic scripts such as Japanese hiragana. Textual images may include images used to convey mathematical meaning, such as Arabic numerals. Textual images may include images used to convey logical meaning, such as logical operators. Textual images may include images that depict other formalized representational encodings of meaning used by human beings. The process may store the identified textual images as character variables. The process may store the identified textual images as strings. The process may store the identified textual images using any similar techniques for storing character data.

In some embodiments, the user interface module 206 generates a user interface 208 with which the user may enter the data identifying the fine. In one of these embodiments, the receiver 202 receives the user interface 208 from the user interface module 206 for display to the user of the first computing device 102.

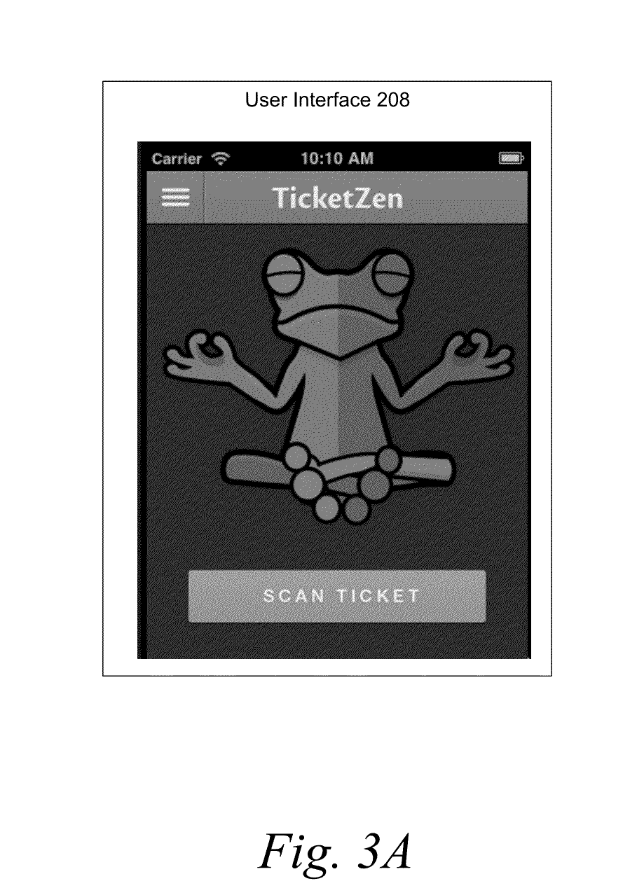

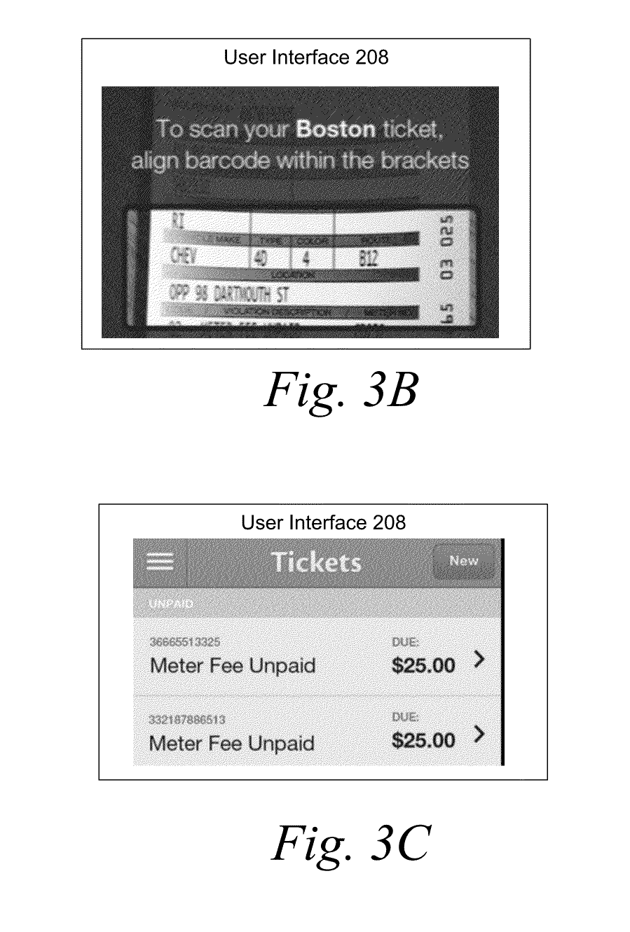

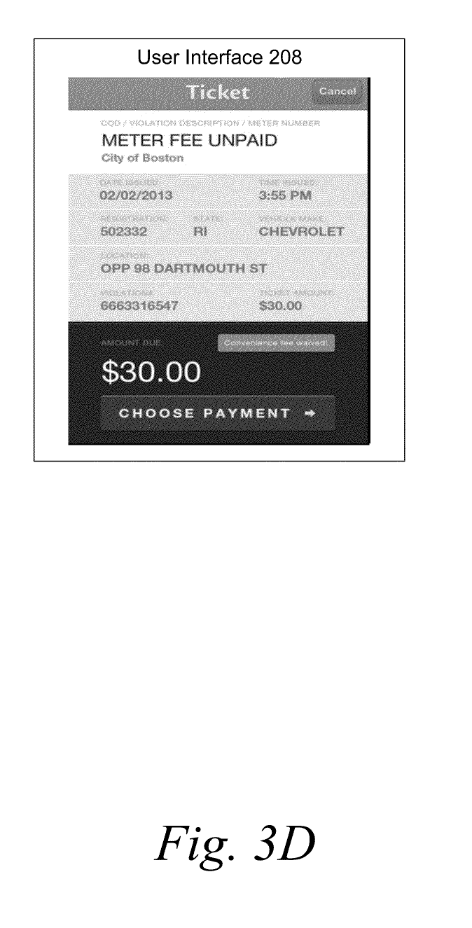

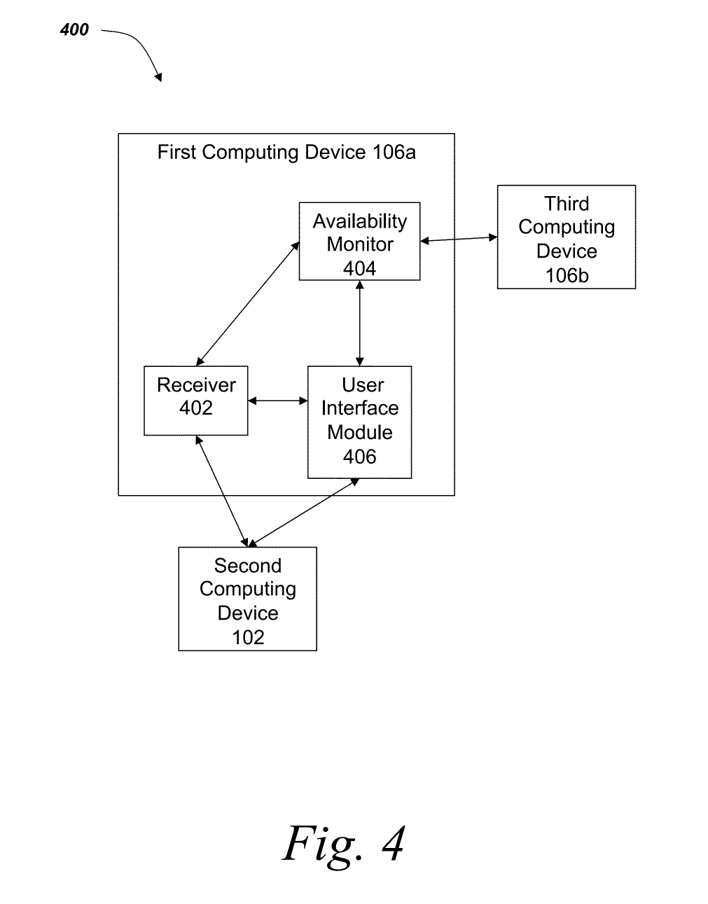

In some embodiments, the user interface module 208 is provided as part of a software application operating on the computing device 202. The user interface 208 may use display devices as described above in reference to FIGS. 1A-1C to prompt user inputs. The user interface 208 may receive data from the user via any I/O devices described above in reference to FIGS. 1A-1C. FIGS. 3A-3D depict various embodiments of user interface 208.

Referring now to FIG. 3A, a block diagram depicts one embodiment of a user interface 208 with which users may provide data identifying fines. As shown in FIG. 3A, the user interface 208 may prompt the user to input data corresponding to a fine, for instance by prompting the user to scan a ticket.

Referring now to FIG. 3B, a block diagram depicts one embodiment of a user interface 208 with which users may scan a ticket. In one embodiment, the user interface 208 provides guidance as to how to position the ticket so that a scanner can scan a barcode on the ticket (e.g., by indicating to the user how to align the ticket with the scanner).

Referring now to FIG. 3C, a block diagram depicts one embodiment of a user interface 208 with which a user may view an enumeration of fines available for payment.

Referring now to FIG. 3D, a block diagram depicts one embodiment of a user interface 208 with which a user may view the data identifying the fine. For example, once the user scans the ticket, the system 200 may display the data identifying the fine in the user interface 208. As another example, the user may access the user interface 208 to confirm the accuracy of the received data. In some embodiments, the user may access the user interface to pay the fine.

Referring back to FIG. 2, and in some embodiments, the availability monitor 204 is provided as part of a software application operating on the first computing device 102. The availability monitor 204 communicates with the second computing device 106 to determine whether the fine may be paid via an online transaction.

Although for ease of discussion the receiver 202, availability monitor 204, and user interface module 206 are described as separate modules, it should be understood that this does not restrict the architecture to a particular implementation. For instance, these modules may be encompassed by a single circuit or software function or may be distributed across multiple applications or computing devices.

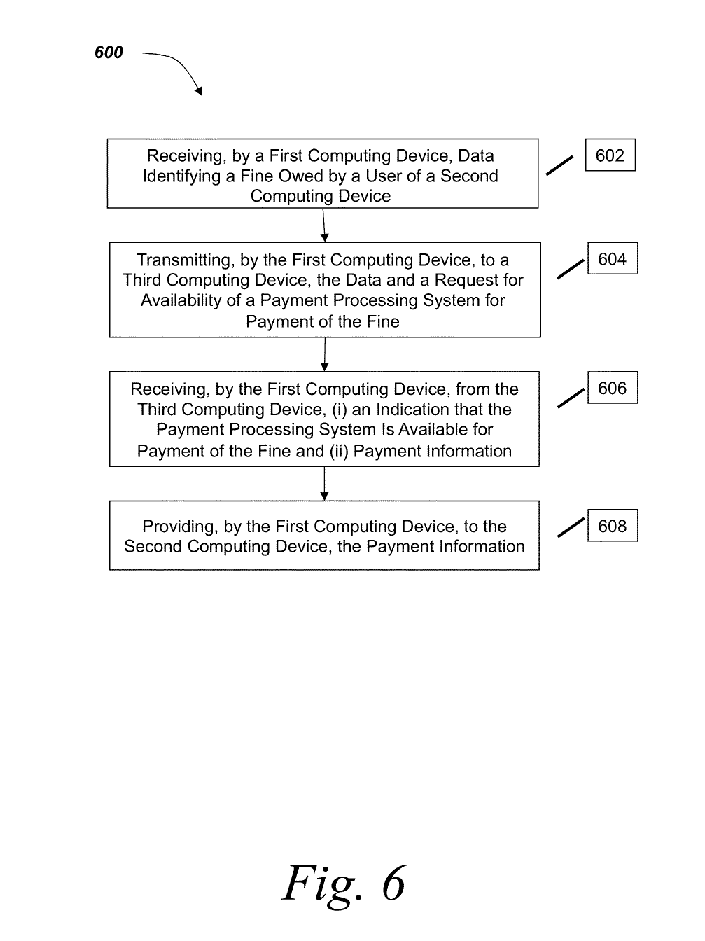

Referring now to FIG. 4, a block diagram depicts one embodiment of a system 400 for determining the availability of a payment processing system. In brief overview, the system includes a first computing device 106a, a second computing device 102, and a third computing device 106b, each of which may be provided as computing devices 100 as described above in connection with FIGS. 1A-1C. The first computing device executes a receiver 402, an availability monitor 404, and a user interface module 406. The receiver 402 may provide the functionality of the receiver 202 described above in connection with FIG. 2. The availability monitor 404 may provide the functionality of the availability monitor 204 described above in connection with FIG. 2. The user interface module 406 may provide the functionality of the user interface module 206 described above in connection with FIG. 2. In some embodiments, and as will be described in greater detail in connection with FIG. 6, the first computing device 106a receives data identifying a fine from the second computing device 102. In such an embodiment, the first computing device 106 executes the functionality for determining the availability of a payment processing system for paying the fine, instead of the second computing device 102.

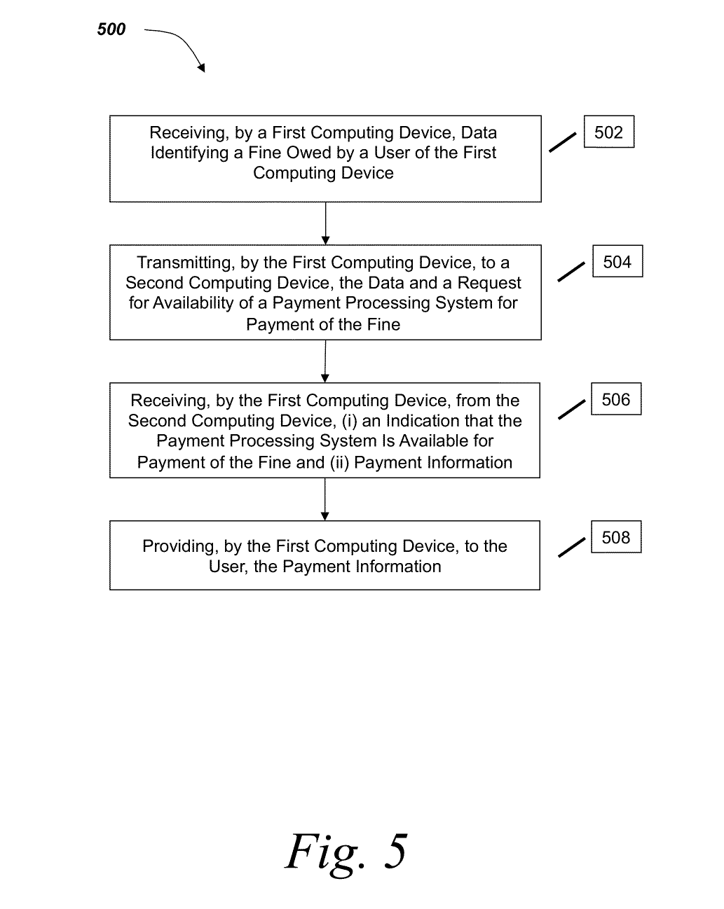

Referring now to FIG. 5, a flow diagram depicts one embodiment of a method 500 for determining availability of a payment processing system. In brief overview, the method 500 includes receiving, by a first computing device, data identifying a fine owed by a user of the first computing device (502). The method 500 includes transmitting, by the first computing device, to a second computing device, the data and a request for availability of a payment processing system for payment of the fine (504). The method 500 includes receiving, by the first computing device, from the second computing device, (i) an indication that the payment processing system is available for payment of the fine and (ii) payment information (506). The method 500 includes providing, by the first computing device, to the user, the payment information (508).

Referring now to FIG. 5 in greater detail, and in connection with FIG. 2, the method 500 includes receiving, by a first computing device, data identifying a fine owed by a user of the computing device (502). In some embodiments, the first computing device scans a ticket specifying a payment obligation. The receiver 204 in some embodiments receives the scanned fine data from a scanner 130a accessible to the computing device. In some embodiments, the receiver 204 receives the data from the user. The user may enter the data using a keyboard. The user may enter the data using a touchscreen. The user may enter the data using a touchpad. The user may enter the data via voice recognition software. The user may enter the data by means of the user interface 208 contained in some embodiments of the receiver 202. In one of these embodiments, the receiver 204 receives the data via a network from another remote machine; for example, the receiver 204 may receive the data from a remote machine operated by the entity to which the fine is owed. In some embodiments, the receiver 204 receives data such as information encoded in a bar code. In other embodiments, the receiver 204 receives data such as an alphanumeric identifier of the ticket. In further embodiments, the receiver 204 receives data associated with the user, such as a date of birth or a driver's license identification number. In some embodiments, the first computing device uses the received data (for example, and without limitation, a user identifier retrieved from a scanned ticket) to determine when subsequent fines are issued; by way of example, the first computing device may store the received data, including a user identifier, and periodically transmit the user identifier to the second computing device with a request for an indication as to whether a fine exists.

The first computing device transmits, to a second computing device, the data and a request for availability of a payment processing system for payment of the fine (504). In some embodiments, the availability monitor 204 transmits the data via a network 104. In some embodiments, the availability monitor 204 locates the second computing device using the data. For example, the data may contain a uniform resource locator (URL) identifying the network address at which the computing device may be found. In some embodiments, the availability monitor 204 uses identification from the data of the entity to which the fine is owed to locate the computing device. For instance, the availability monitor 204 may use an Internet search engine to locate the network address of a computing device pertaining to the identified entity, for example by using the GOOGLE search engine provided by Google, Inc. of Mountain View, Calif. In some embodiments, the availability monitor 204 maintains a list of entities likely to be owed fines in memory accessible to the first computing device 102. For instance, the availability monitor 204 may maintain a list of authorities empowered to issue parking tickets. The availability monitor 204 may compare the data to the list of entities to determine the entity to which the fine is owed. The list of entities in some embodiments contains the network address of a computing device pertaining to each entity. In some embodiments, the availability monitor 204, having located the appropriate entity on the list, uses the corresponding network address on the list to contact the appropriate computing device. In some embodiments, the receiver 202 accepts user inputs identifying entities likely to be owed fines. In some embodiments, the user inputs also include network addresses corresponding to computing devices empowered to accept payment on behalf of those entities.

The first computing device receives, from the second computing device, (i) an indication that the payment processing system is available for payment of the fine and (ii) payment information (506). The availability monitor 204 may request this information by querying the second computing device 106 for data identifying the fine. For example, the availability monitor 204 may enter a datum identifying the fine in a search field presented by the second computing device 106, thus triggering the computing device to search for a fine listed in its system corresponding to that datum. In some embodiments, a non-null result set for the query indicates that the second computing device 106 is available to receive payment for the fine. In some embodiments, the availability monitor 204 parses the query results for data positively indicating that the computing device is available to receive payment. For example, the second computing device 106 may return a form in which an option to pay the fine is activated. In some embodiments, if the result of the query indicates that the second computing device 106 is not available to accept payment, the availability monitor 204 may repeat the querying process until it receives a positive result. The availability monitor 204 may maintain, in memory accessible to the first computing device 102, a time interval at the passage of which the availability monitor 204 will repeat its querying process.

The first computing device provides, to the user, the payment information (508). In some embodiments, the user interface module 206 displays, to the user, data indicating that the computing device 106 is available to receive payment. In one of these embodiments, the user interface module 206 provides the user with instructions for accessing the second computing device 106 and paying the fine through an interface provided by the second computing device 106. In other embodiments, the user interface module 206 simultaneously provides the user with the means to pay the fine; for instance, the user interface module 206 may display a form provided by the second computing device 106 by means of which the second computing device 106 accepts payment from users. Alternatively, the second computing device 106 may not provide a form. In such an alternative embodiment, the user interface 206 may display a user interface 208 requesting payment information and transmits the received payment information to the second computing device 106.

In some embodiments, the availability monitor 204 pays the fine automatically upon receiving data indicating that the second computing device 106 is available to receive payment. In other embodiments, the availability monitor 204 pays the fine on or before a due date received with the payment information. In some embodiments, the availability monitor 204 stores an indication of user's consent to process the payment on behalf of the user. In some embodiments, the availability monitor 204 has account information the user has provided; for instance, the availability monitor 204 may have access to the credit card information of the user. The availability monitor 204 may have access to bank account information of the user. The availability monitor 204 may pay the fine directly on the second computing device 106. The availability monitor 204 may pay the fine via a third-party service. In some embodiments, the first computing device 102 includes a payment module (not shown) that pays the fine. In other embodiments, after the payment of the fine, the computing device 102 provides the user with a receipt indicating that payment has occurred.

Referring now to FIG. 6, a flow diagram depicts one embodiment of a method 600 for determining availability of a payment processing system. In brief overview, the method 600 includes receiving, by a first computing device, data identifying a fine owed by a user of a second computing device (602). The method 600 further includes transmitting, by the first computing device, to a third computing device, the data and a request for availability of a payment processing system for payment of the fine (604). The method 600 also includes receiving, by the first computing device, from the third computing device, (i) an indication that the payment processing system is available for payment of the fine and (ii) payment information (606). The method 600 includes providing, by the first computing device, to the second computing device, the payment information (608), as well.

Referring now to FIG. 6 in greater detail, and in connection with FIG. 4, the method 600 includes receiving, by a first computing device, data identifying a fine owed by a user of a second computing device (602). In some embodiments, instead of receiving the data directly from the user, the receiver 402 receives the data from the second computing device 102. The second computing device 102 may receive the data from the user, scan the data, or otherwise receive the data as described above in connection with FIG. 5.

The first computing device transmits, to a third computing device, the data and a request for availability of a payment processing system for payment of the fine (604). The availability monitor 404 may transmit the data and the request as described above in connection with FIG. 5.

The first computing device receives, from the third computing device, (i) an indication that the payment processing system is available for payment of the fine and (ii) payment information (606). In some embodiments, the availability monitor receives the indication that the payment processing system is available for payment of the fine and the payment information from the third computing device 106b as set forth above with reference to FIG. 5.

The first computing device provides, to the second computing device, the payment information (608). In some embodiments, the user interface module 406 provides the payment information to the second computing device 106a using methods of communication between computing devices set forth above in reference to FIGS. 1A-1C. The second computing device 106a may provide the payment information to the user according to the methods described above in reference to FIG. 5.

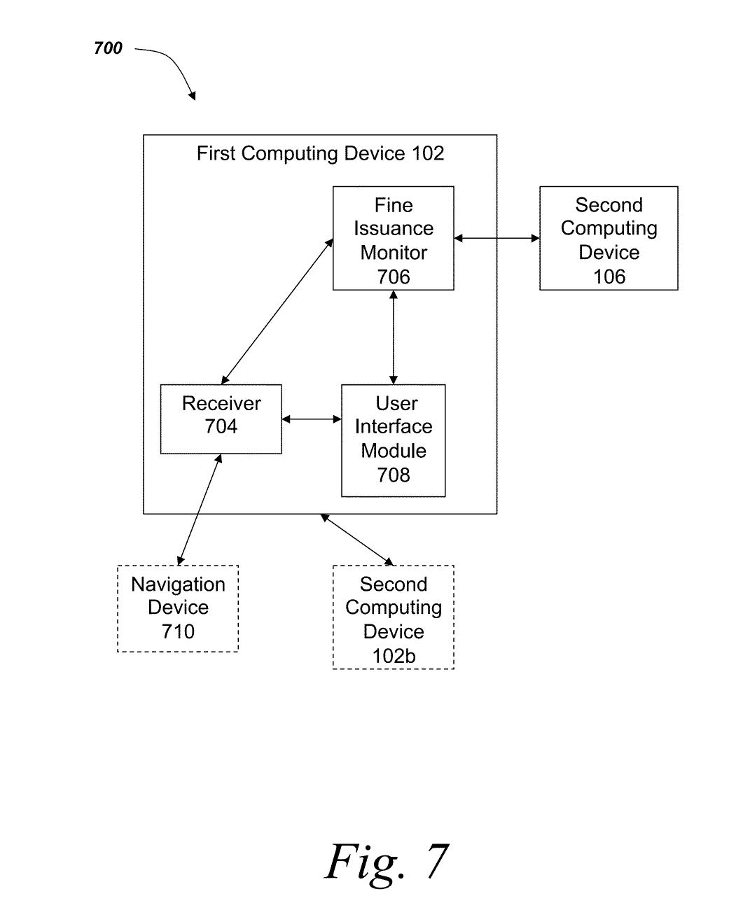

Referring now to FIG. 7, a block diagram depicts one embodiment of a system for monitoring for a new fine owed by a user. In brief overview, the system 700 includes a first computing device 102, a receiver 704 executing on the first computing device 102, a fine issuance monitor 706 executing on the first computing device 102, and a user interface module 708 executing on the first computing device 102.

The system 700 includes a first computing device 102. In some embodiments, the first computing device 102 is a client device 102 as set forth above in reference to FIGS. 1A-1C. In some embodiments, the first computing device 102 is a remote device 106 as set forth above in reference to FIGS. 1A-1C and receives data from a second computing device 102b (depicted in shadow in FIG. 7). The first computing device 102 may receive user input and provide data to a user via a client device 102b (depicted in shadow in FIG. 7) connected to the first computing device 102 by a network as set forth above in reference to FIGS. 1A-1C.

In some embodiments, the receiver 704 is provided as part of a software application operating on the first computing device 102. In some embodiments, the receiver 704 communicates with a navigation device 710 (depicted in shadow in FIG. 7) accessible to the first computing device 102, and adapted to determine the location of the user. In some embodiments, the navigation device 710 is a device that detects the geographical location of the user and communicates that geographical location to the first computing device 102. The navigation device 710 may be a receiver for a satellite-based communication network such as the Global Positioning System (GPS). The navigation device 710 may detect its location by sensing signals from wireless transmitters, and comparing its location to that of the wireless transmitters. The navigation device 710 may detect its location via cell tower triangulation. In some embodiments, the navigation device is separate from the first computing device 102. In some embodiments, the navigation device is integrated in the first computing device 102; for example, the first computing device 102 may be a mobile device operated by the user, and the navigation device may be the GPS receiver built into the mobile device.

In some embodiments, the fine issuance monitor 706 is provided as part of a software application operating on the computing device 102. In some embodiments, the user interface module 708 is provided as part of a software application operating on the computing device 102.

Although for ease of discussion the receiver 704, fine issuance monitor 706, and user interface module 708 are described as separate modules, it should be understood that this does not restrict the architecture to a particular implementation. For instance, these modules may be encompassed by a single circuit or software function.

In some embodiments, the system 700 functions by processing information pertaining to ticketing authorities. A ticketing authority in some embodiments is any entity to which a user may owe a fine. A ticketing authority may be a government agency. A ticketing authority may be a quasi-governmental body. A ticketing authority may be a municipal parking authority. A ticketing authority may be a police department. In some embodiments, a ticketing authority is a private entity. In one of these embodiments, the ticketing authority is a parking garage. In other embodiments, a ticketing authority owns, manages, maintains, accesses, or is otherwise associated with a payment processing system, such as those described above. In some embodiments, the ticketing authority provides the payment processing system. In other embodiments, a third-party provides the payment processing system for the ticketing authority. The second computing device 106 described above may be associated with the ticketing authority, the payment processing system, or both.

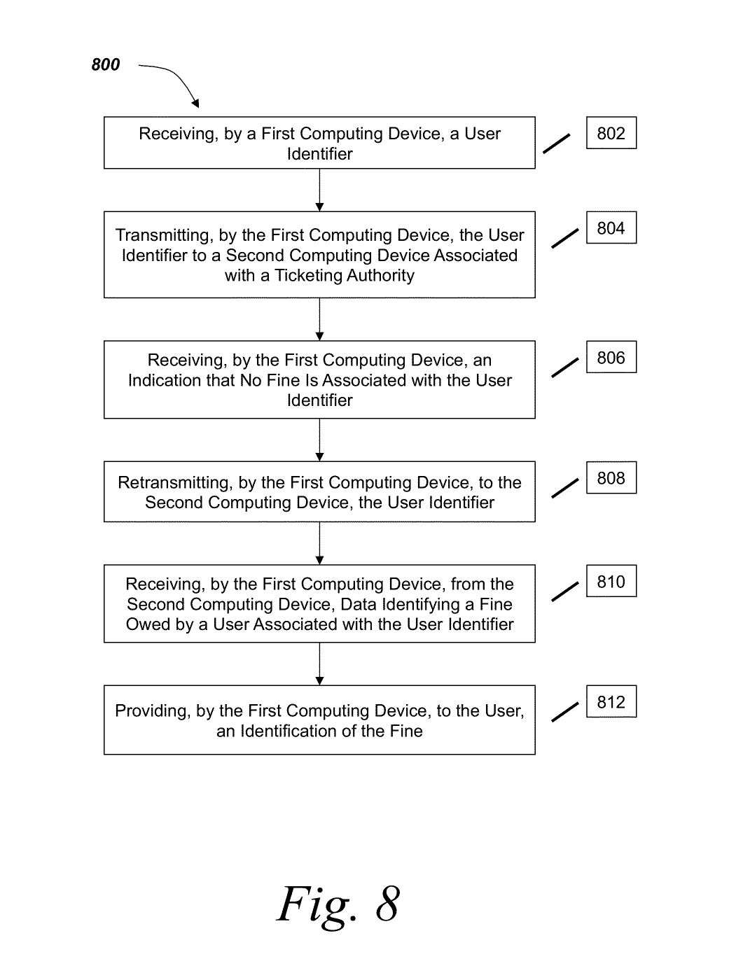

Referring now to FIG. 8, a flow diagram depicts one embodiment of a method 800 for monitoring for a new fine. In brief overview, the method 800 includes receiving, by a first computing device, a user identifier (802). The method 800 includes transmitting, by the first computing device, the user identifier to a second computing device associated with a ticketing authority (804). The method 800 includes receiving, by the first computing device, an indication that no fine is associated with the user identifier (806). The method includes retransmitting, by the first computing device, to the second computing device, the user identifier (808). The method 800 includes receiving, by the first computing device, from the second computing device, data identifying a fine owed by a user associated with the user identifier (810). The method includes providing, by the first computing device, to the user, an identification of the fine (812).

Referring now to FIG. 8 in greater detail, and in connection with FIG. 7, the method 800 includes receiving, by a first computing device, a user identifier (802). In some embodiments, the user inputs the user data (i.e., the user identifier) via I/O devices as described above in reference to FIGS. 1A-1C. In some embodiments, the receiver 704 saves the user data in memory accessible to the first computing device 102, where it can be retrieved later as necessary.

The user data may include data identifying the user. In some embodiments, the user data includes the user's name. In some embodiments, the user data includes a driver's license number. In some embodiments the user data includes an image of a driver's license.

The user data in some embodiments includes a license plate number. The user data in some embodiments includes an image of a license plate. The user data in some embodiments includes information describing a vehicle driven by the user. The user data may include the vehicle identification number of a vehicle driven by the user.

In some embodiments, the user data includes account information usable for paying fines. For instance, the user data may include a credit card number and expiration date for a credit card belonging to the user.

The first computing device transmits the user identifier to a second computing device associated with a ticketing authority (804). In some embodiments, the fine issuance monitor 706 identifies the second computing device 106 by selecting a ticketing authority from a list of likely sources of fines. In some embodiments, the fine issuance monitor 706 generates that list by populating it with ticketing authorities to which the user owed fines in the past. In some embodiments, the fine issuance monitor 706 maintains records of past obligations found by the method 800 in memory accessible to the first computing device 102. The fine issuance monitor 706, in some embodiments, iterates through a list of a plurality of ticketing authorities, and transmits the user identification data to a computing device associated with each of the plurality of ticketing authorities. In other embodiments, the user provides the list via the receiver 704. For example, the user may input ticketing authorities to which the user owed fines in the past via the user interface module 704.

In some embodiments, the first computing device 102 receives location data pertaining to the user, determines a ticketing authority pertaining to the location data, and transmits the user identifier to that ticketing authority. In one of these embodiments, the first computing device 102 receives data describing the current location of the user. In some embodiments, the receiver 704 receives data describing the current location of the user from a navigation device 710 accessible to the first computing device 102. In some embodiments, the receiver 704 receives data describing a location in which the user is habitually located. The user may enter information describing locations associated with the user via the receiver 704 (e.g., a home address or a work address). In some embodiments, the fine issuance monitor 706 determines locations associated with the user by maintaining, in memory accessible to the first computing device 102, a history of places the user has visited previously. In some embodiments, the fine issuance monitor 706 identifies locations associated with the user by maintaining, in memory accessible to the computing device 102, a history of transactions in which the user has previously engaged.

In some embodiments, the fine issuance monitor 706 receives data describing a location the user plans to visit. For example, the user may input, via the user interface module 706, a set of locations the user is planning to visit on an upcoming trip. In other embodiments, the fine issuance monitor 706 receives data describing a jurisdiction to which the user is subject. For instance, the fine issuance monitor 706 may use the driver's license information of the user to determine the jurisdiction that issued the user his or her driver's license. In further embodiments, the fine issuance monitor 706 determines each jurisdiction governing each location to which the user has traveled, using locations determined by the methods described above.

In some embodiments, the fine issuance monitor 706 maintains, in memory accessible to the first computing device 102, a list of governmental bodies responsible for each jurisdiction within a geographical region. In some embodiments, the fine issuance monitor 706 maintains the network address of a computing device associated with each such governmental body. The fine issuance monitor 706 in some embodiments maintains, in memory accessible to the first computing device 102, a list of private entities that possess property within a geographical region. In some embodiments, the fine issuance monitor 706 maintains the network address of a computing device 106 associated with each such ticketing authority. In some embodiments, the fine issuance module 706 uses an Internet search engine to locate the network address of a computing device 106 associated with a ticketing authority.

The first computing device receives an indication that no fine is associated with the user identifier (806). In some embodiments, data indicating that no fine is associated with the user identifier includes a null result, for instance, a failure by the second computing device 106 to respond. In some embodiments, data indicating that no fine is associated with the user identifier excludes null results. In some embodiments, data indicating that no fine is associated with the user includes an affirmative message, such as a message stating that no records were returned for a query. In some embodiments, the first computing device 102 receives an indication that a fine is associated with the user identifier on the first transmission of the user identifier to the second computing device 106. In such embodiments, the first computing device 102 need not retransmit the user identifier to the second computing device 106 as described below, and may instead proceed directly to receiving, from the second computing device 106, data identifying a fine owed by the user as discussed in greater detail below.

The first computing device retransmits, to the second computing device, the user identifier (808). In some embodiments, the fine issuance monitor 706 maintains, in memory accessible to the first computing device 102, a time interval after which the fine issuance monitor 706 retransmits to the second computing device. In some embodiments, the fine issuance monitor 706 determines the time interval by reference to information provided by the ticketing authority. In some embodiments, the fine issuance monitor 706 iterates through a list of ticketing authorities, retransmitting to each ticketing authority in turn. By providing functionality for retransmitting the user identifier and periodically checking whether a fine is available for payment, the methods and systems described herein assist a user in managing outstanding fines and paying such fines promptly, avoiding the inconvenience of having to continue checking whether any fines exist or are outstanding and minimizing late fees and other penalties for neglecting to pay outstanding fines.

The first computing device receives, from the second computing device, data identifying a fine owed by a user associated with the user identifier (810). The first computing device may receive data identifying the fine as described above in connection with FIG. 5.

The first computing device provides, to the user, an identification of the fine (812). In some embodiments, providing involves displaying the fine on the display of the client device 102. In some embodiments, providing involves sending the user an email. In some embodiments, providing involves sending the user a text message via a protocol for sending text messages, such as the short message service (SMS) protocol. In some embodiments, providing involves calling a telephone belonging to the user.

Some embodiments of the method 800 involve paying, by the computing device, the fine. In some embodiments, the fine issuance monitor 406 pays the fine using methods described above in reference to FIG. 5. In other embodiments, the method 800 does not pay the fine, allowing users the flexibility to receive fine notifications without requiring users to provide credit card information.

Some embodiments of the method 800 involve transmitting, by the first computing device 102, the user identifier to a third computing device 106b (not shown) associated with a second ticketing authority; receiving, by the first computing device 102, an indication that no fine is associated with the user identifier; retransmitting, by the first computing device 102, to the third computing device 106b, the user identifier; receiving, by the first computing device 102, from the third computing device 106b, data identifying a second fine owed by the user; and providing, by the first computing device 102, to the user associated with the user identifier, an identification of the second fine. The fine issuance monitor 706 in some embodiments iterates through a list of a plurality of ticketing authorities, and for each ticketing authority performs the steps of transmitting the user identifier to an additional computing device (not shown) associated with that ticketing authority; receiving, by the first computing device 102, an indication that no fine is associated with the user identifier; retransmitting, by the first computing device 102, to the additional computing device, the user identifier; receiving, by the first computing device 102, from the additional computing device, data identifying a second fine owed by the user and providing, by the first computing device 102, to the user associated with the user identifier, an identification of the second fine. In some embodiments, the fine issuance monitor 706 transmits the user identifier to the first ticketing authority to confirm that there are no new, additional fines associated with the user identifier.

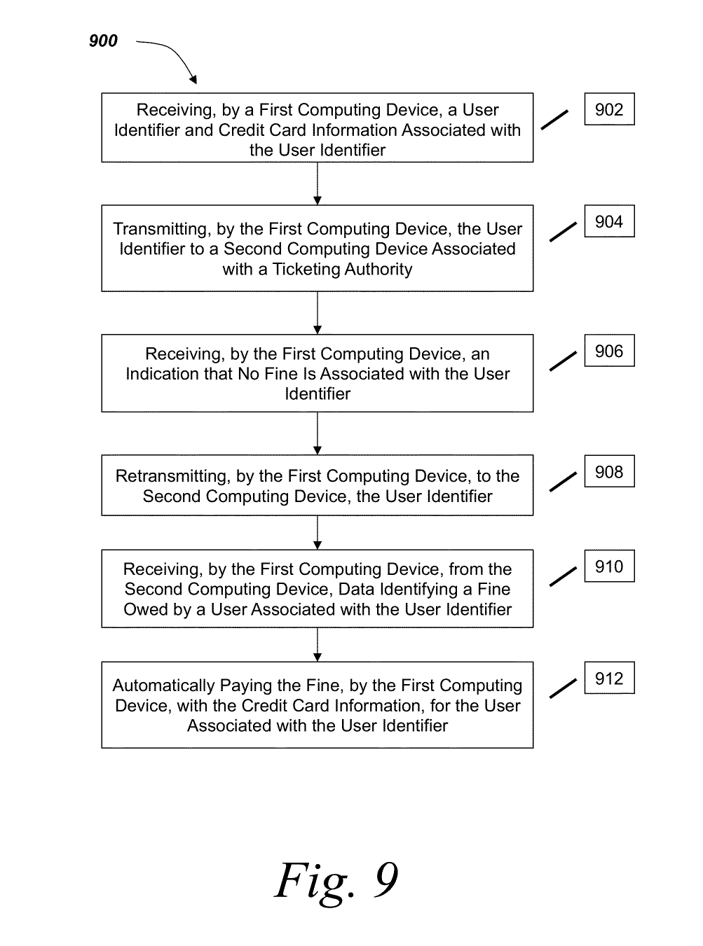

Referring now to FIG. 9, a flow diagram depicts one embodiment of a method 900 for monitoring for a new fine. In brief overview, the method 900 includes receiving, by a first computing device, a user identifier and credit card information associated with the user identifier (902). The method 900 includes transmitting, by the first computing device, the user identifier to a second computing device associated with a ticketing authority (904). The method 900 includes receiving, by the first computing device, an indication that no fine is associated with the user identifier (906). The method 900 includes retransmitting, by the first computing device, to the second computing device, the user identifier (908). The method 900 includes receiving, by the first computing device, from the second computing device, data identifying a fine owed by a user associated with the user identifier (910). The method 900 includes automatically paying the fine, by the first computing device, with the credit card information, for the user associated with the user identifier (912).

Referring now to FIG. 9 in greater detail, and in connection with FIG. 7, the method 900 includes receiving, by a first computing device, a user identifier and credit card information associated with the user identifier (902). In some embodiments, this is implemented as disclosed above in reference to FIG. 8. In some embodiments, the receiver 704 receives the user identifier by receiving a license plate number associated with the user. In other embodiments, the receiver 704 receives the user identifier by accessing data identifying a second fine associated with the user and retrieving the user identifier from the data identifying the second fine. The receiver 704 may access the data identifying the second fine by receiving data describing a payment obligation, as described above in reference to FIG. 5. The data describing the payment obligation may include data associated with the user, as described above in reference to FIG. 5. In some embodiments, the receiver 704 retrieves the user identifier from the data associated with the user. The receiver 704 may access the data identifying the second fine by scanning a ticket, as described above in reference to FIG. 5. By way of example, the receiver 704 may extract a license plate number from a scan of a ticket identifying the second fine and provide the extracted license plate number to the second computing device 106 to determine whether additional fines exist.

The method 900 includes transmitting, by the first computing device, the user identifier to a second computing device associated with a ticketing authority (904). In some embodiments, this is implemented as disclosed above in reference to FIG. 8. In some embodiments, the fine issuance monitor 706 receives location data pertaining to the user, determines a ticketing authority pertaining to the location data, and transmits the user identifier to the determined ticketing authority, as described above in reference to FIG. 8. The fine issuance monitor 706 may receive the location data by receiving information describing a location associated with the user. The fine issuance monitory 706 may receive the location data by receiving, from the user, a set of locations the user is planning to visit. The fine issuance monitor 706 may receive the location data by receiving data describing a jurisdiction to which the user is subject. The fine issuance monitor 706 may receive the location data by maintaining, in memory accessible to the first computing device, a history of places the user has visited previously. The fine issuance monitor 706 may receive the location data by maintaining, in memory accessible to the first computing device, a history of transactions in which the user has previously engaged. The fine issuance monitor 706 may receive the location data by receiving, from a navigation device, a current location of the user.

The method 900 includes receiving, by the first computing device, an indication that no fine is associated with the user identifier (906). In some embodiments, this is implemented as disclosed above in reference to FIG. 8.

The method 900 includes retransmitting, by the first computing device, to the second computing device, the user identifier (908). In some embodiments, this is implemented as disclosed above in reference to FIG. 8.

The method 900 includes receiving, by the first computing device, from the second computing device, data identifying a fine owed by a user associated with the user identifier (910). In some embodiments, this is implemented as disclosed above in reference to FIG. 8.

The method 900 includes automatically paying the fine, by the first computing device, with the credit card information, for the user associated with the user identifier (912). In some embodiments, this is implemented as disclosed above in reference to FIG. 8.

In some aspects, the disclosed systems and methods remove the uncertainty from paying parking tickets and other unexpected fines. A user whose ticket blew off of her windshield before she knew it was there can be notified automatically that the ticket existed, without waiting for the local authorities to inform her that payment is late and she must pay an additional fee. Likewise, the recipient of a ticket can arrange to have the associated fine paid immediately, allowing the disclosed method and system to address the lag time between ticket issuance and availability for online payment. In some embodiments, the recipient of a ticket can arrange to schedule the payment, for example by specifying that a ticket should be paid immediately, paid before the assessment of a late fee, paid within a certain number of days of becoming available for payment, or other user-specified time period. In some embodiments, the municipalities or other entities implementing the methods and systems described herein may provide drivers with the benefits of automatically knowing whether or not there are outstanding fines and even, in some of these embodiments, with the ability to have the fine automatically paid—without requiring the implementing entities to acquire and deploy new hardware. In one of these embodiments, by way of example and without limitation, implementing entities do not need to retrain employees who monitor vehicles and issue fines, do not need to provide such employees with special equipment, and do not need to make special fine payment equipment (hardware or software) available to recipients of fines. In another of these embodiments, therefore, fine-issuing entities may continue to issue fines according to conventional methods but, by implementing the methods and systems described herein, may provide fine recipients with the ability to automatically learn when any such fines have been issued and address the payment of the fines; for example, and without limitation, the fine-issuing entities may provide this functionality by simply providing to the systems described herein the ability to access the fine-issuing entities such as, for example, by providing interfaces or protocols with which the systems described herein may access fine-issuing infrastructure. Such implementations may allow fine-issuing entities to increase likelihood of fine recipients making timely payments of their fines.

It should be understood that the systems described above may provide multiple ones of any or each of the described components and these components may be provided on either a standalone machine or, in some embodiments, on multiple machines in a distributed system. The phrases ‘in one embodiment,’ ‘in another embodiment,’ and the like, generally mean the particular feature, structure, step, or characteristic following the phrase is included in at least one embodiment of the present disclosure and may be included in more than one embodiment of the present disclosure. Such phrases may, but do not necessarily, refer to the same embodiment.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, Python, C, C++, C#, JAVA, Ruby, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions described in this document by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for determining availability of a payment processing system, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for monitoring for a new fine, the method comprising:
receiving, by a first computing device, a user identifier and credit card information associated with the user identifier;
transmitting, by the first computing device, the user identifier to a second computing device associated with a ticketing authority;
receiving, by the first computing device, an indication that no fine is associated with the user identifier;
retransmitting, by the first computing device, to the second computing device, the user identifier;
receiving, by the first computing device, from the second computing device, data identifying a fine owed by a user associated with the user identifier; and
automatically paying the fine, by the first computing device, with the credit card information, for the user associated with the user identifier.

2. The method of claim 1, wherein receiving the user identifier further comprises receiving a license plate number associated with the user.

3. The method of claim 1, wherein receiving the user identifier further comprises:
accessing data identifying a second fine associated with the user; and
retrieving the user identifier from the data identifying the second fine.

4. The method of claim 3, wherein accessing the data identifying the second fine further comprises scanning a ticket.

5. The method of claim 1, wherein transmitting further comprises:
receiving, by the first computing device, location data pertaining to the user;
determining a ticketing authority pertaining to the location data; and
transmitting the user identifier to the determined ticketing authority.

6. The method of claim 5, wherein receiving location data further comprises receiving information describing a location associated with the user.

7. The method of claim 5, wherein receiving location data further comprises receiving, from the user, a set of locations the user is planning to visit.

8. The method of claim 5, wherein receiving location data further comprises receiving data describing a jurisdiction to which the user is subject.

9. The method of claim 5, wherein receiving location data further comprises maintaining, in memory accessible to the first computing device, a history of places the user has visited previously.

10. The method of claim 5, wherein receiving location data further comprises maintaining, in memory accessible to the first computing device, a history of transactions in which the user has previously engaged.

11. The method of claim 5, wherein receiving location data further comprises receiving, from a navigation device, a current location of the user.

12. A method for monitoring for a new fine, the method comprising:
receiving, by a first computing device, a user identifier;
transmitting, by the first computing device, the user identifier to a second computing device associated with a ticketing authority;
receiving, by the first computing device, an indication that no fine is associated with the user identifier;
retransmitting, by the first computing device, to the second computing device, the user identifier;
receiving, by the first computing device, from the second computing device, data identifying a fine owed by a user associated with the user identifier; and
providing, by the first computing device, to the user, an identification of the fine.

13. The method of claim 12, wherein providing the identification further comprises providing an identification of a late fee.

14. The method of claim 12 further comprising:
retransmitting the user identifier to the second computing device;
receiving an indication that the fine has not been paid;
providing, by the first computing device, to the user, a second identification of the fine.

15. The method of claim 14, wherein retransmitting occurs after receiving the data identifying the fine.

16. The method of claim 12 further comprising providing, by the first computing device, the user with means to pay the fine.

17. The method of claim 12 further comprising automatically paying the fine, by the first computing device, for the user.

18. A system for monitoring for a new fine, the system comprising:
a receiver, executing on a first computing device, (i) receiving a user identifier and credit card information associated with the user identifier, (ii) receiving, from a second computing device associated with a ticketing authority, an indication that no fine is associated with the user identifier, (iii) receiving, from the second computing device, data identifying a fine owed by a user associated with the user identifier, and (iv) providing, to the user, an identification of the fine; and
a fine issuance monitor, executing on the first computing device, transmitting the user identifier to the second computing device, and retransmitting, to the second computing device, the user identifier.
